(19) United States
(12) Patent Application Publication
(10) Pub. No.: US 2026/0251934 A1
(43) Pub. Date: Aug. 27, 2026

(54) VIRTUAL IMAGE DISPLAY APPARATUS AND OPTICAL UNIT

(71) Applicant: SEIKO EPSON CORPORATION, Tokyo (JP)

(72) Inventors: Takashi TAKEDA, SUWA-SHI (JP); Katsutoshi INOMOTO, SHIOJIRI-SHI (JP)

(73) Assignee: SEIKO EPSON CORPORATION, Tokyo (JP)

(21) Appl. No.: 19/550,310

(22) Filed: Feb. 26, 2026

(30) Foreign Application Priority Data
Feb. 27, 2025 (JP) 2025-029875

(51) Int. Cl. G02F 1/1335; G02B 5/30

(52) U.S. Cl. CPC G02F 1/133555; G02B 5/3083

(57) ABSTRACT

A virtual image display apparatus includes: a display panel outputting video light and transmitting external light; a selectively reflective film reflecting light circularly polarized in a first rotational direction, and transmitting light circularly polarized in a second rotational direction opposite the first rotational direction; and a semi-transmissive reflective film partially transmitting incident light and reflect the incident light. The semi-transmissive reflective film partially transmits the video light output from the display panel. The selectively reflective film reflects the video light passing through the semi-transmissive reflective film. The semi-transmissive reflective film partially reflects the video light reflected off the selectively reflective film. The selectively reflective film transmits the video light reflected off the semi-transmissive reflective film. The semi-transmissive reflective film transmits a part of the external light passing through the display panel. The selectively reflective film transmits the external light passing through the semi-transmissive reflective film.

The present application is based on, and claims priority from JP Application Serial Number 2025-029875, filed February 27, 2025, the disclosure of which is hereby incorporated by reference herein in its entirety.

### BACKGROUND

### 1. Technical Field

The present disclosure relates to a virtual image display apparatus and an optical unit that enable observation of a virtual image, particularly to a see-through virtual image display apparatus and the like that displays a virtual image and transmits external light and an optical unit.

### 2. Related Art

As a see-through virtual image display apparatus that enables visual recognition of the outside space, there is a known head mounted display including a frame mounted on an observer's head, a video source that is disposed as a portion of the frame that corresponds to the side surface of the observer's head and outputs video light having specific polarization, and a selective reflector that is disposed as a portion of the frame that corresponds to the observer's eye and selectively reflects only light having the specific polarization (JP-A-2016-102891).

JP-A-2016-102891 is an example of the related art.

To make a head mounted display (hereinafter, referred to as "HMD") operate like typical eyeglasses in terms of shape, dimensions, weight, and the like, it is essential to widen the field of view and reduce the thickness of the head mounted display. To achieve both a wide field of view and a small thickness of an HMD, it is necessary to use a plate-shaped member as a member corresponding to a lens of eyeglasses. In this case, to secure the length of the optical path of the optical system that guides video light representing a virtual image to the wearer's eye, it is necessary to employ an optical system of a type in which the video light is deflected back in the plate-shaped member. In a single optical element provided in the plate-shaped member, to switch the reflection and transmission of the video light from one to the other before and after the deflection, a waveplate that changes the state of the polarization of the video light in the middle of the plate-shaped member is required. In the see-through HMD, it is further necessary to transmit the external light separated from the video light to cause the external light to reach the wearer's eyes.

### SUMMARY

In view of the circumstances described above, there is provided a virtual image display apparatus and an optical unit that make a see-through HMD thin. Other problems and novel features will be apparent from the description of the present specification and the accompanying drawings.

According to an embodiment, a virtual image display apparatus includes: a display panel configured to output video light and transmit external light; a selectively reflective film configured to reflect light circularly polarized in a first rotational direction as the light circularly polarized in the first rotational direction, and transmit light circularly polarized in a second rotational direction opposite the first rotational direction as the light circularly polarized in the second rotational direction; and a semi-transmissive reflective film provided between the display panel and the selectively reflective film and configured to transmit a part of incident light and reflect another part of the incident light. The semi-transmissive reflective film is configured to partially transmit the video light output from the display panel. The selectively reflective film is configured to reflect the video light passing through the semi-transmissive reflective film. The semi-transmissive reflective film is configured to partially reflect the video light reflected off the selectively reflective film. The selectively reflective film is configured to transmit the video light reflected off the semi-transmissive reflective film. The semi-transmissive reflective film is configured to transmit a part of the external light passing through the display panel. The selectively reflective film is configured to transmit the external light passing through the semi-transmissive reflective film.

According to another embodiment, an optical unit includes: a display panel configured to output video light and transmit external light; a selectively reflective film configured to reflect circularly polarized light having a polarization plane rotating in a first rotational direction as the circularly polarized light having a polarization plane rotating in the first rotational direction, and transmit circularly polarized light having a polarization plane rotating in a second rotational direction opposite the first rotational direction as the circularly polarized light having a polarization plane rotating in the second rotational direction; and a semi-transmissive reflective film provided between the display panel and the selectively reflective film and configured to transmit a part of incident light and reflect another part of the incident light. The semi-transmissive reflective film is configured to partially transmit the video light output from the display panel. The selectively reflective film is configured to reflect the video light passing through the semi-transmissive reflective film. The semi-transmissive reflective film is configured to partially reflect the video light reflected off the selectively reflective film. The selectively reflective film is configured to transmit the video light reflected off the semi-transmissive reflective film. The semi-transmissive reflective film is configured to transmit a part of the external light passing through the display panel. The selectively reflective film is configured to transmit the external light passing through the semi-transmissive reflective film.

According to another embodiment, a see-through HMD can be made thin.

### BRIEF DESCRIPTION OF THE DRAWINGS

FIG. 1 is an exterior front view illustrating a state in which virtual image display apparatuses according to a first embodiment are mounted.

FIG. 2 is a conceptual side view illustrating the structure of a display optical system.

FIG. 3 is a conceptual perspective view illustrating the structure of a CLC element.

FIG. 4 is a perspective view illustrating the positional relationship among a transmissive light source member, a first polarizer, a transmissive liquid crystal panel, a second polarizer, and a quarter-wave plate.

FIG. 5 is a conceptual enlarged cross-sectional view illustrating the structure of a display unit.

FIG. 6 illustrates the state of light passing through the display unit.

FIG. 7 illustrates the state of video light passing through an imaging optical system.

FIG. 8 illustrates a change in the polarization state of the video light passing through the imaging optical system.

FIG. 9 illustrates the state of the video light passing through the imaging optical system.

FIG. 10 illustrates the state of the video light passing through the imaging optical system.

FIG. 11 illustrates the state of the video light passing through the imaging optical system.

FIG. 12 is a conceptual enlarged cross-sectional view illustrating the structure of the display unit.

FIG. 13 is a conceptual enlarged cross-sectional view illustrating the structure of the display unit.

FIG. 14 is a time chart illustrating drive signals used by a drive circuit to drive transmissive light source members and a time-sequential half-wave, liquid crystal plate.

### DESCRIPTION OF EMBODIMENTS

A virtual image display apparatus and an optical unit according to embodiments of the present disclosure will be described below with reference to the accompanying drawings.

### First embodiment

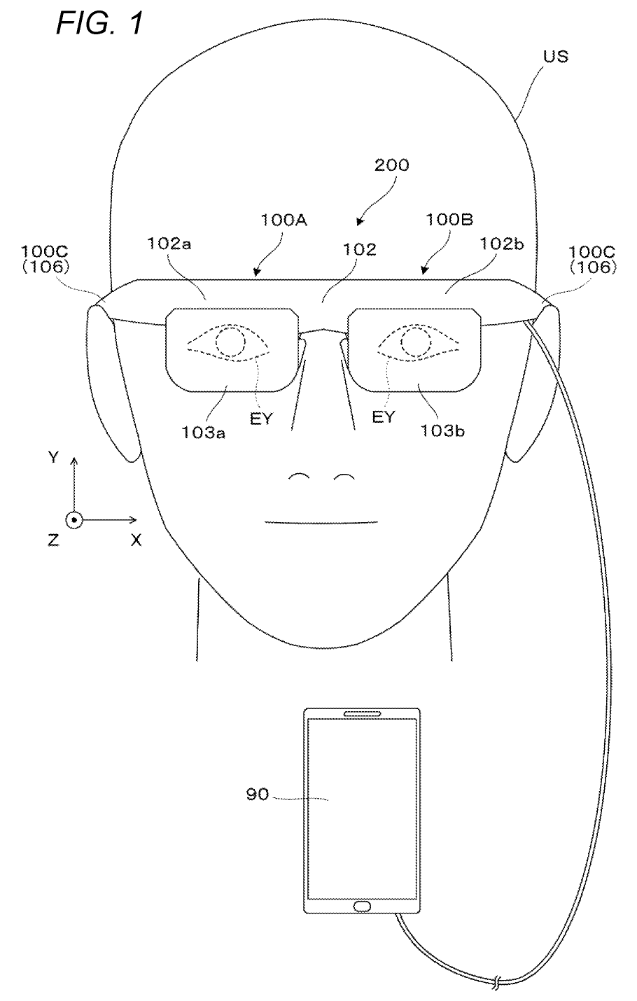

Virtual image display apparatuses 100A and 100B and an optical unit 100 according to a first embodiment of the present disclosure will be described below with reference to FIGS. 1 to 8.

FIG. 1 is an exterior front view illustrating a state in which a head mounted display 200 is mounted. The head mounted display (hereinafter also referred to as HMD) 200 allows an observer or a wearer US, who wears the HMD 200, to recognize a video in the form of virtual images. In FIG. 1 and other figures, X, Y, and Z form an orthogonal coordinate system, a +X direction corresponds to a lateral direction in which two eyes EY of the observer or the wearer US, who wears the HMD 200, are arranged, a +Y direction corresponds to an upward direction perpendicular to the lateral direction with respect to the wearer US, in which the two eyes EY are arranged, and a +Z direction corresponds to a forward or frontward direction with respect to the wearer US. The ±Y directions are parallel to the vertical axis or the vertical direction.

The HMD 200 includes a first virtual image display apparatus 100A for the right eye, a second virtual image display apparatus 100B for the left eye, a pair of temples 100C, which support the virtual image display apparatuses 100A and 100B, and a user terminal 90, which is an information terminal. The first virtual image display apparatus 100A includes a first display driver 102a disposed on the upper side, and a first display optical system 103a, which covers the front of the right eye. The second virtual image display apparatus 100B includes a second display driver 102b disposed on the upper side, and a second display optical system 103b, which covers the front of the left eye. The HMD 200, which is the combination of the first virtual image display apparatus 100A and the second virtual image display apparatus 100B, is also a virtual image display apparatus in a broad sense. The pair of temples 100C are mounting members or supports 106 worn at the head of the wearer US, and support the upper ends of the pair of display optical systems 103a and 103b via the display drivers 102a and 102b integrated with each other in appearance. The combination of the pair of display drivers 102a and 102b is called a drive apparatus 102.

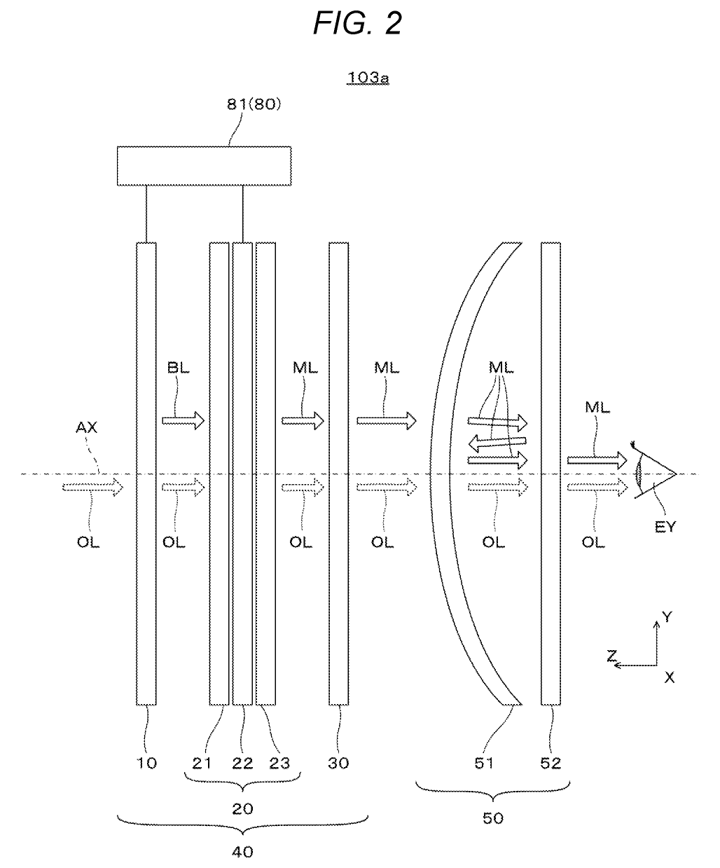

FIG. 2 is a conceptual side view illustrating the structure of the first display optical system 103a. The first display optical system 103a includes a plate-shaped display unit 40, which forms a two-dimensional image, outputs video light ML corresponding to the two-dimensional image, and transmits at least a part of external light OL, and an imaging optical system 50, which functions as a lens affecting the video light ML output from the display unit 40 and forms a virtual image. In FIG. 2, transparent members disposed between elements that constitute the first display optical system 103a are omitted, and the distances between the elements are enlarged for easier understanding of the configuration of the first display optical system 103a.

The display unit 40 includes a transmissive light source member 10, a display element 20, which forms and outputs the video light ML, and a quarter-wave plate 30. The transmissive light source member 10 includes a light emitter that generates white backlight BL and a light transmissive portion that transmits the external light OL. The display unit 40 operates when driven by a drive circuit 81 of a controller 80 incorporated in the first display driver 102a or the drive apparatus 102. The display element 20 of the display unit 40 is disposed close to the eye EY with the imaging optical system 50 interposed therebetween, and enables observation of a virtual image formed by the video light ML and see-through viewing of the outside space. In the first display optical system 103a, the distance between the eye EY and the imaging optical system 50 in the direction of an optical axis AX is in a range, for example, between about 15 mm and 35 mm. The distance between a transmissive liquid crystal panel 22 of the display unit 40 and the imaging optical system 50 in the direction of the optical axis AX is in a range, for example, between about 3 mm and 20 mm.

The display element 20 is a plate-shaped member extending along an XY plane perpendicular to the optical axis AX, and includes a first polarizer 21, the transmissive liquid crystal panel 22 as a display panel, and a second polarizer 23 sequentially arranged from the side facing the outside space. The display element 20 has a structure in which the polarizers 21 and 23 and the transmissive liquid crystal panel 22 are stacked on each other into a single unit surrounded by a frame that is not shown. The first polarizer 21 and the transmissive liquid crystal panel 22 are disposed close to each other at a distance smaller than or equal to a predetermined value. The transmissive liquid crystal panel 22 and the second polarizer 23 are disposed close to each other at a distance smaller than or equal to a predetermined value. The transmissive liquid crystal panel 22 is an imager that forms first video light containing a first color component, second video light containing a second color component, and third video light containing a third color component in a time division manner, the first video light, the second video light, and the third video light constituting the video light ML. Note that the transmissive liquid crystal panel 22 has multiple pixels arranged in a matrix along the XY plane.

The quarter-wave plate 30 has a polarization characteristic of converting light linearly polarized in a first direction out of incident light into light circularly polarized in a first rotational direction and outputting the circularly polarized light, and converting light linearly polarized in a second direction perpendicular to the first direction out of the incident light into light circularly polarized in a second rotational direction opposite the first rotational direction and outputting the circularly polarized light. As an example, the quarter-wave plate 30 may convert, out of the incident light, light linearly polarized in the longitudinal direction (Y direction) viewed from the eye EY into left-handed circularly polarized light and output the circularly polarized light, and may convert, out of the incident light, light linearly polarized in the lateral direction (X direction) viewed from the eye EY into right-handed circularly polarized light and output the circularly polarized light. As an example, the video light ML output by the display element 20 may be light linearly polarized in the longitudinal direction (Y direction) viewed from the eye EY, and the external light OL having passed through the transmissive light source member 10 and the display element 20 may be light linearly polarized in the lateral direction (X direction) viewed from the eye EY.

The imaging optical system 50 is disposed on a side of the display unit 40 or the display element 20 that is the side facing the face of the observer, that is, on the −Z side of the display unit 40 or the display element 20, and covers the front of the eye. The imaging optical system 50 is a plate-shaped member extending along the XY plane, and includes a semi-transmissive reflective film 51 and a selectively reflective film 52 arranged sequentially from the side facing the outside space. The imaging optical system 50 further includes one or more transparent members that are not shown. The semi-transmissive reflective film 51 and the selectively reflective film 52 may be formed on a surface of a first transparent member and a surface of a second transparent member different from the first transparent member, respectively, or may be formed at a first surface of a single transparent member and a second surface facing the first surface, respectively. The imaging optical system 50 has a structure in which optical elements that constitute the imaging optical system 50, that is, the semi-transmissive reflective film 51 and the selectively reflective film 52 are disposed close to each other with an appropriate gap interposed therebetween, and the films are integrated into a single unit by a frame that is not shown. The integration makes the optical performance of the imaging optical system 50 stable and makes the imaging optical system 50 thin. Note that, including a case where a transparent member is disposed between the semi-transmissive reflective film 51 and the selectively reflective film 52, the elements described above can be directly fixed to each other via an adhesive into a single unit, or the elements described above can be brought into close contact with each other and fixed to each other at the outer circumference thereof into a single unit.

The semi-transmissive reflective film 51 transmits a part of the incident light and reflects another part of the incident light irrespective of the polarization state of the incident light. In the process described above, out of the incident light, the ratio of the intensity of the light passing through the semi-transmissive reflective film 51 to the intensity of the light reflected off the semi-transmissive reflective film 51 is not limited to 1, and may be set to a desired value. The semi-transmissive reflective film 51 has a concave curved surface facing the selectively reflective film 52. Out of the light incident from the selectively reflective film 52, the light reflected off the semi-transmissive reflective film 51 travels toward the selectively reflective film 52 while converging due to the positive power produced by the concave curved surface of the semi-transmissive reflective film 51.

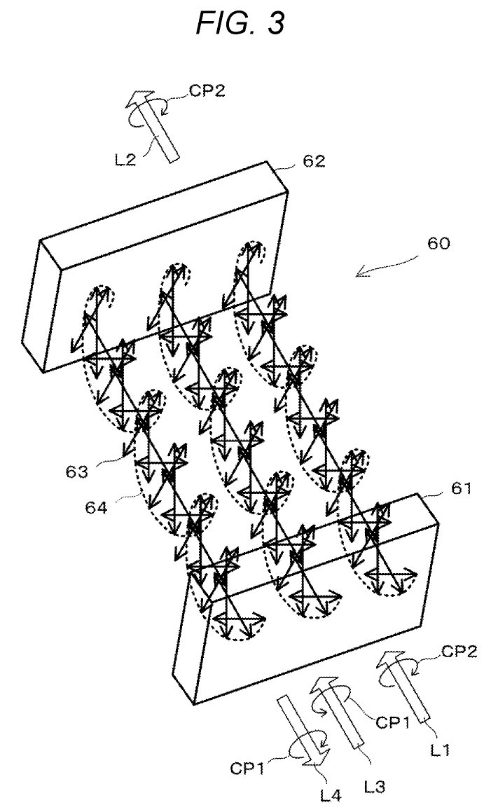

Out of the incident light, the selectively reflective film 52 reflects light circularly polarized in one rotational direction as the light circularly polarized in the one rotational direction, and transmits light circularly polarized in the other rotational direction as light circularly polarized in the other rotational direction in accordance with the polarization state of the incident light. It should be noted that when a typical reflective film, including the semi-transmissive reflective film 51, reflects circularly polarized light, the rotational direction in which the reflected light is circularly polarized is opposite the rotational direction in which the incident light is circularly polarized, so that the above optical characteristics of the selectively reflective film 52 are special characteristics. Such optical characteristics can be realized, for example, by configuring the selectively reflective film 52 with a cholesteric liquid crystal (CLC) element. A CLC element 60 includes a liquid crystal director 63 provided between two transparent substrates 61 and 62 arranged in parallel to and facing each other, as shown in FIG. 3. The liquid crystal director 63 is a set of liquid crystal molecules oriented in a direction parallel to the planar direction in which the two transparent substrates 61 and 62 extend. In the CLC element 60, a spiral structure 64 is so formed that the direction in which the liquid crystal molecules are oriented cyclically rotates clockwise or counterclockwise with respect to the axial direction parallel to the direction in which the two transparent substrates face each other when the light travels from one of the two transparent substrates toward the other transparent substrate. Light L1 and light L3 that enter the CLC element 60 pass through the CLC element 60 and become light L2 having circular polarization CP2 when the rotational direction in which the light L1 and the light L3 are circularly polarized is the same as the rotational direction of the spiral structure 64 of the CLC element 60 or the rotational direction of the circular polarization CP2, and is reflected off the CLC element 60 and becomes light L4 having circular polarization CP1 when the rotational direction in which the light L1 and the light L3 are circularly polarized is opposite the rotational direction of the spiral structure 64 of the CLC element 60 or the rotational direction of the circular polarization CP1. As an example, when the selectively reflective film 52 reflects left-handed circularly polarized light, the polarization state of the light reflected off the selectively reflective film 52 is the left-handed circular polarization, which is the same as that of the light immediately before reflection The left-handed circularly polarized light reflected off the selectively reflective film 52 is reflected again off the semi-transmissive reflective film 51 and becomes right-handed circularly polarized light, and travels toward the selectively reflective film 52. The right-handed circularly polarized light passes through the selectively reflective film 52 and travels toward the eye EY.

As a result, the imaging optical system 50 functions as a lens affecting the video light ML output from the display element 20. That is, the imaging optical system 50 forms images of the multiple pixels as a whole, which are provided in the transmissive liquid crystal panel 22, and enables the observation of a video formed on the transmissive liquid crystal panel 22 as virtual images. The imaging optical system 50 further functions as a plane-parallel plate affecting the external light OL passing through the display element 20. That is, the external light OL passes straight through the display element 20 to be observed as a direct-view image.

The second display optical system 103b is optically the same as the first display optical system 103a, or is a horizontally flipped version of the first display optical system 103a, and will therefore not be described in detail.

Note that an optical apparatus that is the first virtual image display apparatus 100A from which the controller 80 is excluded is called an optical unit 100. Similarly, an optical apparatus that is the second virtual image display apparatus 100B from which the controller 80 is excluded is called the optical unit 100.

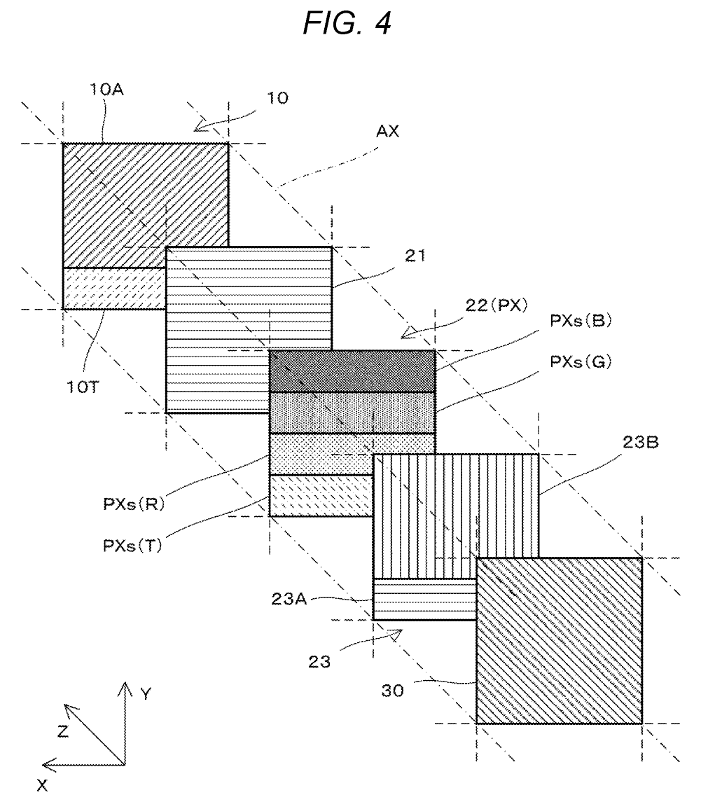

FIG. 4 is a perspective view illustrating the positional relationship among the transmissive light source member 10, the first polarizer 21, the transmissive liquid crystal panel 22, the second polarizer 23, and the quarter-wave plate 30 in the direction parallel to the optical axis AX at each of multiple pixels that constitute an image indicated by the video light ML generated by the transmissive liquid crystal panel 22. In the example shown in FIG. 4, the multiple pixels are arranged in a lattice in the X and Y directions, and the optical axis AX is parallel to the Z direction.

The transmissive light source member 10 includes a segmented OLED (organic light emitting diode) panel having a light emission region 10A, via which the white backlight BL is emitted, and a transparent region 10T, through which the external light OL passes. The transmissive light source member 10 may include multiple light emission regions 10A and multiple transparent regions 10T. The light emission regions 10A and the transparent regions 10T are alternately arranged one by one in a first arrangement direction contained in the XY plane with the two regions adjacent to each other. The light emission regions 10A and the transparent regions 10T each extend in a second arrangement direction contained in the XY plane and perpendicular to the first arrangement direction. The light emission regions 10A and the transparent regions 10T may each extend in a band shape over the entire transmissive light source member 10 in the second arrangement direction, or the light emission regions 10A and the transparent regions 10T may be alternately arranged one by one in the first arrangement direction, as shown in the example in FIG. 4. In the example shown in FIG. 4, the first arrangement direction is parallel to the X direction, and the second arrangement direction is parallel to the Y direction, but not necessarily in the present embodiment.

The first polarizer 21 selectively transmits light linearly polarized in the first polarization direction out of the incident light. In the example shown in FIG. 4, the first polarizer 21 selectively transmits light linearly polarized in the direction parallel to the X direction.

The transmissive liquid crystal panel 22 has multiple pixels PXs, which each include a first-color sub-pixel PXs(R), a second-color sub-pixel PXs(G), a third-color sub-pixel PXs(B), and a transparent region PXs(T), which transmits the external light OL. In each of the pixels PX, the first-color sub-pixel PXs(R), the second-color sub-pixel PXs(G), the third-color sub-pixel PXs(B), and the transparent region PXs(T) are arranged adjacent to each other in the second arrangement direction. The first-color sub-pixel PXs(R), the second-color sub-pixel PXs(G), the third-color sub-pixel PXs(B), and the transparent region PXs(T) are not necessarily arranged in a specific order in the first arrangement direction. In each of the pixels PX, the first-color sub-pixel PXs(R), the second-color sub-pixel PXs(G), the third-color sub-pixel PXs(B), and the transparent region PXs(T), which transmits the external light OL, extend in the second arrangement direction. The transparent region PXs(T) may extend in a band shape across the multiple pixels PX adjacent to each other in the second arrangement direction, or may be integrated into a single region. In the configuration example shown in FIG. 4, the sub-pixels PXs(R), PXs(G), and PXs(B), and the transparent region PXs(T) provided in each of the pixels PX have the same width in the first arrangement direction, which is merely an example, and does not limit the present embodiment. As an example, the ratio of the width of the transparent region PXs(T) in the first arrangement direction to the width of the pixel PX in the first arrangement direction may be changed in any manner. The ratio of the width of each of the sub-pixels PXs(R), PXs(G), and PXs(B) in the first arrangement direction to the width of the pixel PX in the first arrangement direction may be changed in any manner. In any of the cases described above, however, the sub-pixels PXs(R), PXs(G), and PXs(B) are arranged so as to face the light emission region 10A in a way that the backlight BL from the light emission region 10A of the transmissive light source member 10 is not incident on the transparent regions PXs(T), but is incident on the sub-pixels PXs(R), PXs(G), and PXs(B). The transparent regions PXs(T) are disposed so as to face the transparent region 10T in a way that the external light OL from the transparent region 10T of the transmissive light source member 10 is not incident on the sub-pixel PXs(R), PXs(G), or PXs(B), but is incident on the transparent regions PXs(T).

The second polarizer 23 has a first polarization region 23A, which selectively transmits the light linearly polarized in the first polarization direction, and a second polarization region 23B, which selectively transmits light linearly polarized in a second polarization direction perpendicular to the first polarization direction. The second polarizer 23 may include multiple first polarization regions 23A and multiple second polarization regions 23B. The first polarization regions 23A and the second polarization regions 23B are alternately arranged one by one in the first arrangement direction contained in the XY plane with the two regions adjacent to each other. The first polarization regions 23A and the second polarization regions 23B each extend in the second arrangement direction. The first polarization regions 23A and the second polarization regions 23B may each extend in a band shape over the entire second polarizer 23 in the second arrangement direction. The pattern indicating the positional relationship between the first polarization regions 23A and the second polarization regions 23B in the second polarizer 23 is not limited to the regular pattern shown in the example in FIG. 4. In any of the cases described above, however, the second polarization region 23B is disposed so as to face the sub-pixels PXs(R), PXs(G), and PXs(B) in a way that the first video light, the second video light, and the third video light output by the sub-pixels PXs(R), PXs(G), and PXs(B) are not incident on the first polarization region 23A, but are incident on the second polarization region 23B. The first polarization region 23A is disposed so as to face the transparent region 10T and the transparent regions PXs(T) in a way that the external light OL having passed through the transparent region 10T, the first polarizer 21, and the transparent regions PXs(T) is not incident on the second polarization region 23B but is incident on the first polarization region 23A.

The light emission region 10A of the transmissive light source member 10 and the sub-pixels PXs(R), PXs(G), and PXs(B) of the transmissive liquid crystal panel 22 are arranged so as to face each other. The sub-pixels PXs(R), PXs(G), and PXs(B) of the transmissive liquid crystal panel 22 and the second polarization region 23B of the second polarizer 23 are arranged so as to face each other. The sub-pixels PXs(R), PXs(G), and PXs(B) of the transmissive liquid crystal panel 22 are irradiated with the backlight BL output from the light emission region 10A of the transmissive light source member 10 to output the video light ML. The video light ML passes through the second polarization region 23B of the second polarizer 23 so that the video light ML has a first polarization state. As an example, the video light ML having the first polarization state may be light linearly polarized in a direction parallel to the predetermined first polarization direction contained in the XY plane.

The transparent region 10T of the transmissive light source member 10 and the transparent regions PXs(T) of the transmissive liquid crystal panel 22 are disposed to face each other. The transparent regions PXs(T) of the transmissive liquid crystal panel 22 and the first polarization region 23A of the second polarizer 23 are arranged to face each other. The external light OL passes through the transparent region 10T of the transmissive light source member 10 and the transparent regions PXs(T) of the transmissive liquid crystal panel 22, then passes through the first polarization region 23A of the second polarizer 23, so that the external light OL has a second polarization state. The external light OL having the second polarization state may be light linearly polarized in a direction contained in the XY plane and parallel to the second polarization direction perpendicular to the first polarization direction.

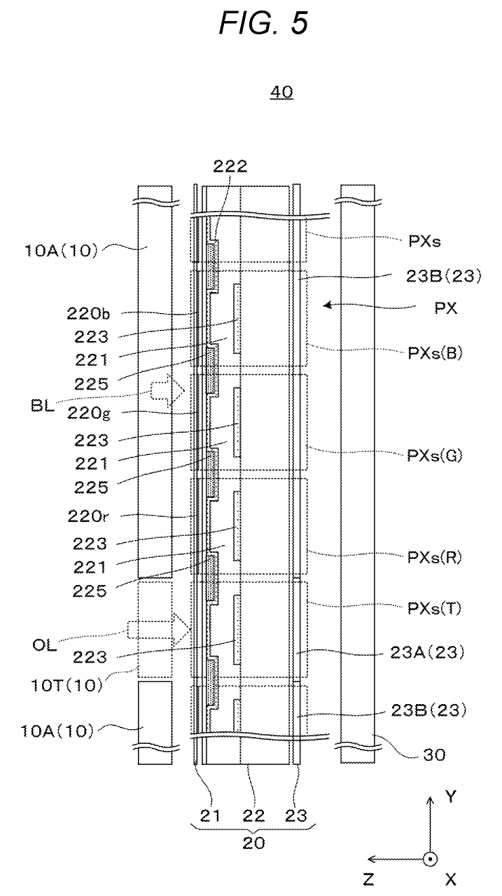

FIG. 5 is a conceptual enlarged cross-sectional view illustrating the structure of the display unit 40. Referring to FIG. 5, the transmissive light source member 10 supplies the transmissive liquid crystal panel 22 of the display element 20 with white light as the backlight BL. The transmissive light source member 10 may generate the white backlight BL by simultaneously generating three types of color backlight.

The display element 20 is disposed on a side of the transmissive light source member 10 or the first polarizer 21 that is the side facing the face of the observer, that is, on the −Z side of the transmissive light source member 10 or the first polarizer 21. The display element 20 includes the transmissive liquid crystal panel 22 and the pair of polarizers 21 and 23, which sandwich the transmissive liquid crystal panel 22. In this case, the display element 20 is, for example, a modulator configured with an in-plane switching (IPS) liquid crystal molecules and operates on a pixel basis throughout the pixels PX. The pixels PX each include the first-color sub-pixel PXs(R), the second-color sub-pixel PXs(G), the third-color sub-pixel PXs(B), and the transparent region PXs(T). The first-color sub-pixel PXs(R) includes a first-color color filter 220r, the second-color sub-pixel PXs(G) includes a second-color color filter 220g, and the third-color sub-pixel PXs(B) includes a third-color color filter 220b. The transparent region PXs(T) has no color filter and is colorless. The display element 20, when no electric field is applied thereto, does not rotate the polarization direction of the incident light, but when an electric field is applied thereto, rotates the polarization direction of the incident light. In this case, the first polarizer 21 and the second polarization region 23B of the second polarizer 23 are absorptive polarization elements, and are so disposed that the polarization directions thereof intersect with each other, more specifically, the polarization directions are perpendicular to each other. The display element 20 can switch its operation state between an ON state and an OFF state on a pixel basis throughout the pixels PX in accordance with a drive signal from the drive circuit 81 (see FIG. 2), and can partially transmit the incident light having any gray level between the level in the ON state and the level in the OFF state. To this end, the transmissive liquid crystal panel 22 includes not only a liquid crystal layer 221, a common electrode 222, pixel electrodes 223, and a black matrix 225 but also scan lines, signal lines, switching elements, and the like, none of which is shown. Regarding the transparent regions PXs(T), however, the pixel electrodes 223 can be omitted, and the transmittance of the transparent regions PXs(T) corresponding to the external light OL can be improved by omitting the pixel electrodes 223. The transmissive liquid crystal panel 22 is preferably configured with a high-temperature polysilicon (HTPS) panel to achieve high-definition display.

The first-color color filter 220r selectively transmits first-color light out of the backlight BL. Similarly, the second-color color filter 220g selectively transmits second-color light out of the backlight BL. The third-color color filter 220b selectively transmits third-color light out of the backlight BL. As an example, the first color is red (r: red) corresponding to wavelengths in a range between about 620 nm (nanometers) and about 750 nm, the second color is green (g: green) corresponding to wavelengths in a range between about 495 nm and about 570 nm, and the third color is blue (b: blue) corresponding to wavelengths in a range between about 450 nm and about 495 nm. Hereinafter, out of any light, a portion having wavelengths that fall within the range of the first color is called a first-color wavelength component of the light, a portion having wavelengths that fall within the range of the second color is called a second-color wavelength component of the light, and a portion having wavelengths that fall within the range of the third color is called a third-color wavelength component of the light.

The first-color sub-pixel PXs(R) imparts an intensity controlled by the controller 80 (see FIG. 2) to the first-color light, which is the first-color wavelength component contained in the backlight BL, and outputs the resultant light as the first video light, which is the first-color wavelength component, which constitutes the video light ML, to display a first video representing the intensity distribution of the first-color wavelength component out of the video indicated by the video light ML. Similarly, the second-color sub-pixel PXs(G) imparts an intensity controlled by the controller 80 to the second-color light, which is the second-color wavelength component contained in the backlight BL, and outputs the resultant light as the second video light, which is the second-color wavelength component, which constitutes the video light ML, to display a second video representing the intensity distribution of the second-color wavelength component out of the video indicated by the video light ML. The third-color sub-pixel PXs(B) imparts an intensity controlled by the controller 80 to the third-color light, which is the third-color wavelength component contained in the backlight BL, and outputs the resultant light as the third video light, which is the third-color wavelength component, which constitutes the video light ML, to display a third video representing the intensity distribution of the third-color wavelength component out of the video indicated by the video light ML. The pixels PX can each represent various colors by combining the first video light output by the first-color sub-pixel PXs(R), the second video light output by the second-color sub-pixel PXs(G), and the third video light output by the third-color sub-pixel PXs(B) with one another.

Note that the display element 20 or the transmissive liquid crystal panel 22, when no electric field is applied thereto, may rotate the polarization direction of the incident light, but when an electric field is applied thereto, may not rotate the polarization direction of the incident light. In this case, the first polarizer 21 and the second polarization region 23B of the second polarizer 23 are so disposed that the polarization directions thereof are parallel to each other.

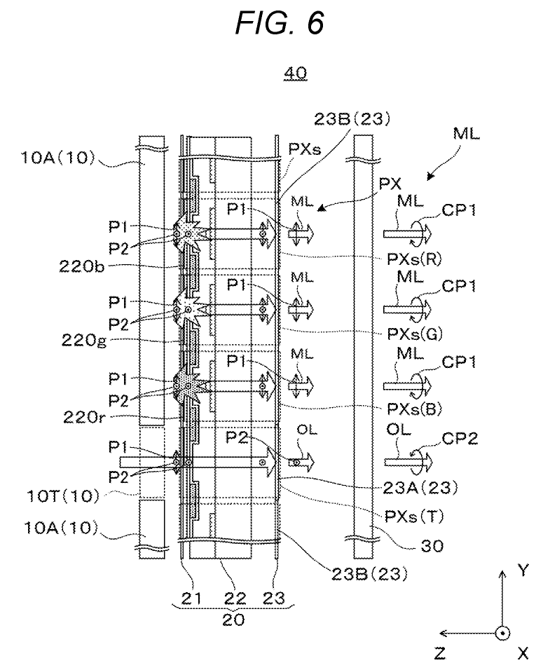

FIG. 6 illustrates the state of the light passing through the display unit 40. The light emission region 10A of the transmissive light source member 10 emits light in response to a control signal from the controller 80 shown in FIG. 2, and the backlight BL is output toward the display element 20. The transmissive liquid crystal panel 22 is illuminated with the backlight BL as second linearly polarized light P2, which is laterally or horizontally polarized light, via the first polarizer 21 of the display element 20. That is, out of each of the pixels PX, which constitute the display element 20, the sub-pixels PXs(R), PXs(G), and PXs(B) facing the light emission region 10A of the transmissive light source member 10 are illuminated. The video light ML having passed through the transmissive liquid crystal panel 22 is the backlight BL the polarization plane of which has been rotated in accordance with the drive signal, and only first linearly polarized light P1, which is longitudinally or vertically polarized light, is output via the second polarization region 23B of the second polarizer 23. The video light ML output from the sub-pixels PXs(R), PXs(G), and PXs(B) contained in each of the pixels PX of the display element 20 is converted from the first linearly polarized light P1 into the first circularly polarized light CP1 via the quarter-wave plate 30. As an example, the first circularly polarized light CP1 is left-handed circularly polarized light the polarization plane of which rotates counterclockwise when viewed in the traveling direction.

The external light OL passes through the transparent region 10T of the transmissive light source member 10 and enters the display element 20. The transparent region PXs(T) contained in each of the pixels PX of the display element 20 is transparent to the external light OL, and the second linearly polarized light P2 out of the external light OL incident on the transparent region PXs(T) contained in each of the pixels PX of the display element 20 travels straight through the first polarizer 21, the transparent region PXs(T), and the first polarization region 23A of the second polarizer 23 provided in the display element 20, and is converted into the second linearly polarized light P2. The external light OL output from the display element 20 is converted from the second linearly polarized light P2 into the second circularly polarized light CP2 via the quarter-wave plate 30. As an example, the second circularly polarized light CP2 is right-handed circularly polarized light the polarization plane of which rotates clockwise when viewed in the traveling direction. The rotation direction of the polarization plane of the second circularly polarized light CP2 is opposite the rotation direction of the polarization plane of the first circularly polarized light CP1.

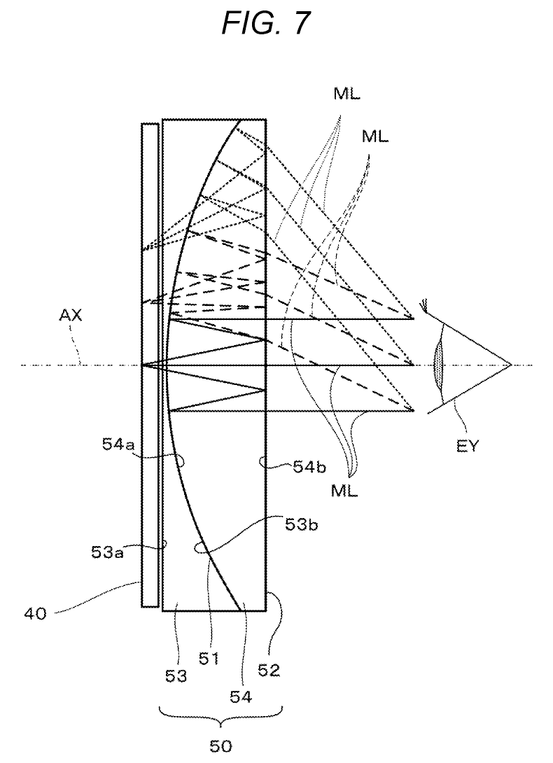

FIG. 7 illustrates the state of the video light ML passing through the imaging optical system 50. In the example shown in FIG. 7, the imaging optical system 50 includes the semi-transmissive reflective film 51, the selectively reflective film 52, and transparent members 53 and 54. As an example, the first transparent member 53 has a first surface 53a facing the display unit 40 and a second surface 53b facing the first surface 53a, and the semi-transmissive reflective film 51 is formed on the second surface 53b of the first transparent member 53. As an example, the second transparent member 54 has a third surface 54a facing the second surface 53b of the first transparent member 53 and a fourth surface 54b facing the third surface 54a, and the selectively reflective film 52 is formed on the fourth surface 54b of the second transparent member 54. In the example shown in FIG. 7, the first surface 53a of the first transparent member 53 is a light incident surface of the imaging optical system 50, and has a planar shape perpendicular to the optical axis AX. The fourth surface 54b of the second transparent member 54 is a light exiting surface of the imaging optical system 50 and has a planar shape perpendicular to the optical axis AX. The configuration described above is, however, merely an example, and does not limit the present disclosure. As another example, the semi-transmissive reflective film 51 may be formed on the third surface 54a of the second transparent member 54.

The video light ML output from the display unit 40 passes through the semi-transmissive reflective film 51, is reflected off the selectively reflective film 52, is reflected off the semi-transmissive reflective film 51, and passes through the selectively reflective film 52 during the period from the point where the video light ML enters the imaging optical system 50 to the point where the video light ML exits therefrom, as shown in FIG. 7. When the video light ML from the selectively reflective film 52 is reflected off the semi-transmissive reflective film 51 and travels toward the selectively reflective film 52, the video light ML converges due to the positive power produced by the semi-transmissive reflective film 51 because the semi-transmissive reflective film 51 has a concave curved surface facing the selectively reflective film 52. As a result, the video light ML is brought into focus when reaching the eye EY.

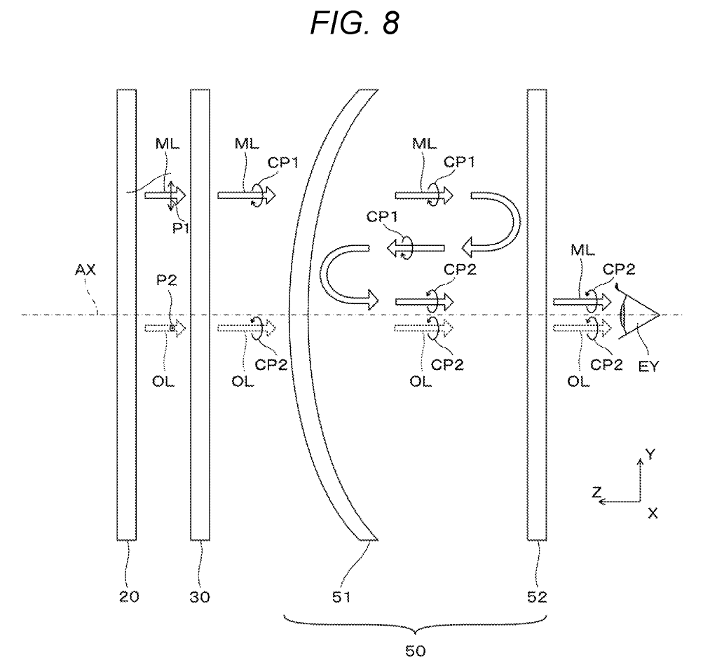

FIG. 8 illustrates a change in the polarization state of the video light ML passing through the imaging optical system 50. As described above with reference to FIG. 6, the polarization state of the video light ML output from the quarter-wave plate 30 of the display unit 40 is the first circular polarization CP1. When the video light ML from the quarter-wave plate 30 enters the imaging optical system 50, the video light ML is incident on the semi-transmissive reflective film 51. Out of the video light ML incident on the semi-transmissive reflective film 51, a part of the video light ML passes through the semi-transmissive reflective film 51, and another part of the video light ML is reflected off the semi-transmissive reflective film 51 in terms of intensity. Out of the video light ML incident on the semi-transmissive reflective film 51, the portion reflected off the semi-transmissive reflective film 51 does not reach the eye EY, and is therefore not shown. Out of the video light ML incident on the semi-transmissive reflective film 51, the polarization state of the portion having passed through the semi-transmissive reflective film 51 is the same as that of the video light ML before being incident on the semi-transmissive reflective film 51, and remains as the first circular polarization CP1 in the example shown in FIG. 8.

The video light ML having passed through the semi-transmissive reflective film 51 is reflected off the selectively reflective film 52, which reflects the first circularly polarized light CP1 and transmits the second circularly polarized light CP2. The polarization state of the video light ML reflected off the selectively reflective film 52 is the same as that of the video light ML before being reflected off the selectively reflective film 52, and remains as the first circular polarization CP1 in the example shown in FIG. 8.

The video light ML reflected off the selectively reflective film 52 is incident on the semi-transmissive reflective film 51. Out of the video light ML incident on the semi-transmissive reflective film 51, a part of the video light ML passes through the semi-transmissive reflective film 51, and another part of the video light ML is reflected off the semi-transmissive reflective film 51 in terms of intensity. Out of the video light ML incident on the semi-transmissive reflective film 51, the portion having passed through the semi-transmissive reflective film 51 does not reach the eye EY, and is therefore not shown. Out of the video light ML incident on the semi-transmissive reflective film 51, the polarization state of the portion reflected off the semi-transmissive reflective film 51 is circular polarization having a polarization plane rotating in the direction opposite the direction in which the polarization plane of the video light ML before being reflected off the semi-transmissive reflective film 51, and is the second circular polarization CP2 in the example shown in FIG. 8.

The video light ML reflected off the semi-transmissive reflective film 51 passes through the selectively reflective film 52 and reaches the eye EY. The polarization state of the video light ML having passed through the selectively reflective film 52 is the same as that of the video light ML before being incident on the selectively reflective film 52, and remains as the second circular polarization CP2 in the example shown in FIG. 8.

Although not shown in FIG. 7, the polarization state of the external light OL having passed through the display unit 40 is the second circular polarization CP2, as described with reference to FIG. 6, and out of the external light OL having entered the imaging optical system 50, the polarization state of the external light OL having passed through the semi-transmissive reflective film 51 remains the second circular polarization CP2 as shown in FIG. 8. The external light OL having passed through the semi-transmissive reflective film 51 is therefore not reflected off the selectively reflective film 52 but passes through the selectively reflective film 52 and reaches the eye EY. It is preferable that the transparent members 53 and 54 have the same refractive index so that the external light OL reaching the eye EY is not unnecessarily distorted.

Each of the virtual image display apparatuses 100A and 100B or the optical unit 100 according to the first embodiment described above includes the display panel 22, the selectively reflective film 52, and the semi-transmissive reflective film 51. The display panel 22 outputs the video light ML and transmits the external light OL. The selectively reflective film 52 reflects the circularly polarized light CP1, the polarization plane of which rotates in the first rotation direction, as the circularly polarized light CP1, the polarization plane of which rotates in the first rotation direction, and transmits the circularly polarized light CP2, the polarization plane of which rotates in the second rotation direction opposite the first rotation direction, as the circularly polarized light CP2, the polarization plane of which rotates in the second rotation direction. The semi-transmissive reflective film 51 is provided between the display panel 22 and the selectively reflective film 52, transmits a part of the incident light, and reflects another part of the incident light. The semi-transmissive reflective film 51 partially transmits the video light ML output by the display panel 22. The selectively reflective film 52 reflects the video light ML having passed through the semi-transmissive reflective film 51. The semi-transmissive reflective film 51 partially reflects the video light ML reflected off the selectively reflective film 52. The selectively reflective film 52 transmits the video light ML reflected off the semi-transmissive reflective film 51. The semi-transmissive reflective film 51 transmits a part of the external light OL having passed through the display panel 22. The selectively reflective film 52 transmits the external light OL having passed through the semi-transmissive reflective film 51.

Each of the virtual image display apparatuses 100A and 100B or the optical unit 100 described above employs the configuration in which the semi-transmissive reflective film 51, which has a concave curved surface, and the selectively reflective film 52, which selectively transmits or reflects circularly polarized light in accordance with the rotation direction of the polarization plane of the circularly polarized light, are effectively combined with each other, so that reduction in thickness, size, and weight of the see-through HMD 200 can be realized.

### Second embodiment

The virtual image display apparatuses 100A and 100B and the like according to a second embodiment will be described below. Note that the virtual image display apparatuses 100A and 100B according to the second embodiment are partially changed versions of the virtual image display apparatuses 100A and 100B according to the first embodiment, and portions common to those of the virtual image display apparatuses 100A and 100B according to the first embodiment will not be described.

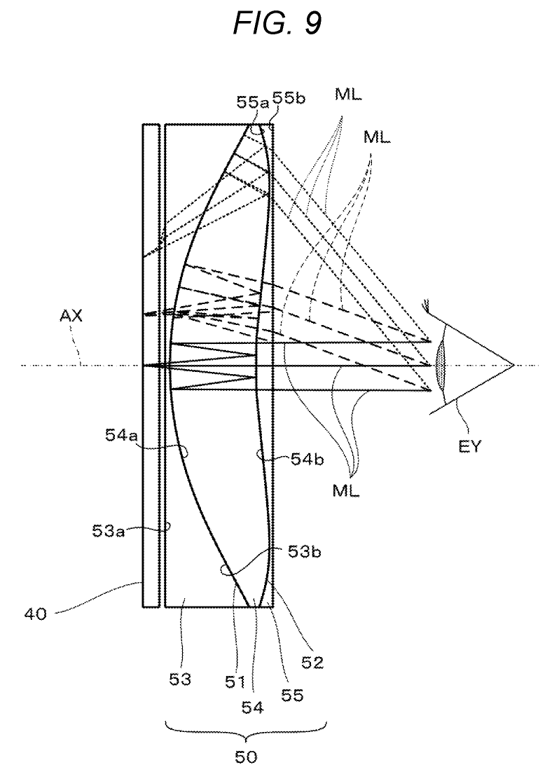

The virtual image display apparatuses 100A and 100B according to the second embodiment primarily differ from the virtual image display apparatuses 100A and 100B according to the first embodiment shown in FIG. 7 in that the surface of the selectively reflective film 52 is changed in shape from the planar surface to a curved surface, as shown in FIG. 9. In the example shown in FIG. 9, the selectively reflective film 52 has a convex curved surface facing the semi-transmissive reflective film 51. In the second embodiment, the shape of the surface of the semi-transmissive reflective film 51 is also changed as appropriate from the curved surface in the first embodiment in accordance with the shape of the surface of the selectively reflective film 52. As an example, the power produced by the concave semi-transmissive reflective film 51 may be greater than the power produced by the convex selectively reflective film 52.

Note that a third transparent member 55 is added to make a surface of the imaging optical system 50 that is the surface facing the eye EY planar. The third transparent member 55 has a fifth surface 55a facing the fourth surface 54b of the second transparent member 54 and a sixth surface 55b facing the fifth surface 55a. The fifth surface 55a of the third transparent member 55 has the same curved shape as the selectively reflective film 52. The sixth surface 55b of the third transparent member 55 is a planar surface perpendicular to the optical axis AX and forms a surface of the imaging optical system 50 that is the surface facing the eye EY. In the first embodiment, the selectively reflective film 52 is formed on the fourth surface 54b of the second transparent member 54, which is the surface facing the eye EY, whereas in the second embodiment, the selectively reflective film 52 may be formed on the fourth surface 54b of the second transparent member 54 as in the first embodiment, or may be formed on the fifth surface 55a of the third transparent member 55.

In the second embodiment, the shape of the surface of the semi-transmissive reflective film 51 and the shape of the surface of the selectively reflective film 52 are cooperatively responsible for the function of causing the video light ML that will reach the eye EY to converge so that the video light ML is brought into focus. As a result, in the second embodiment, the thickness, size, and weight of the see-through HMD 200 can be further reduced as compared with those in the first embodiment.

### Third embodiment

The virtual image display apparatuses 100A and 100B and the like according to a third embodiment will be described below. Note that the virtual image display apparatuses 100A and 100B according to the third embodiment are partially changed versions of the virtual image display apparatuses 100A and 100B according to the first embodiment, and portions common to those of the virtual image display apparatuses 100A and 100B according to the first embodiment will not be described.

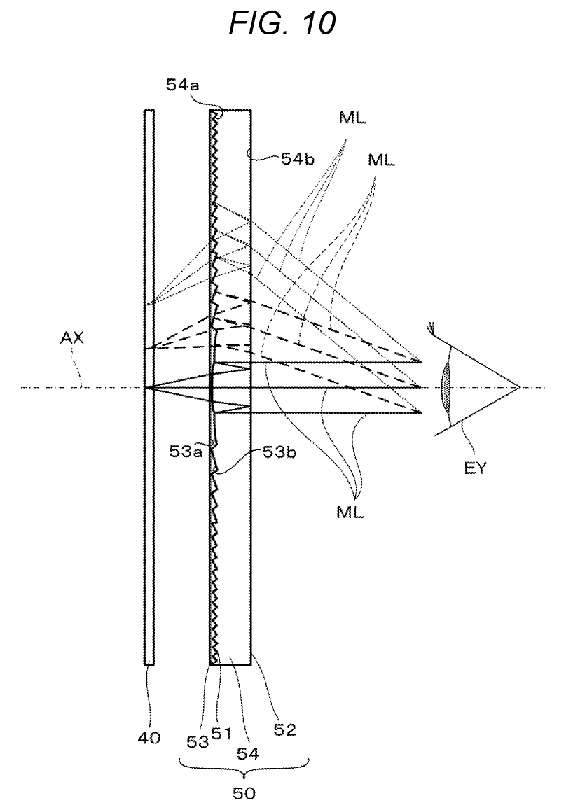

The virtual image display apparatuses 100A and 100B according to the third embodiment primarily differ from the virtual image display apparatuses 100A and 100B according to the first embodiment shown in FIG. 7 in that the surface of the semi-transmissive reflective film 51 is changed in shape from the concave curved surface facing the selectively reflective film 52 to a concave Fresnel lens facing the selectively reflective film 52, as shown in FIG. 10.

In the third embodiment, the shape of the surface of the semi-transmissive reflective film 51 and the shape of the surface of the selectively reflective film 52 are cooperatively responsible for the function of causing the video light ML that will reach the eye EY to converge so that the video light ML is brought into focus. As a result, in the third embodiment, the thickness, size, and weight of the see-through HMD 200 can be greatly reduced as compared with those in the first embodiment.

### Fourth embodiment

The virtual image display apparatuses 100A and 100B and the like according to a fourth embodiment will be described below. Note that the virtual image display apparatuses 100A and 100B according to the fourth embodiment are partially changed versions of the virtual image display apparatuses 100A and 100B according to the first, second, or third embodiments, in other words, the fourth embodiment is the combination of the second and third embodiments. In the virtual image display apparatuses 100A and 100B according to the fourth embodiment, portions common to those of the virtual image display apparatuses 100A and 100B according to the first, second, or third embodiment will not be described.

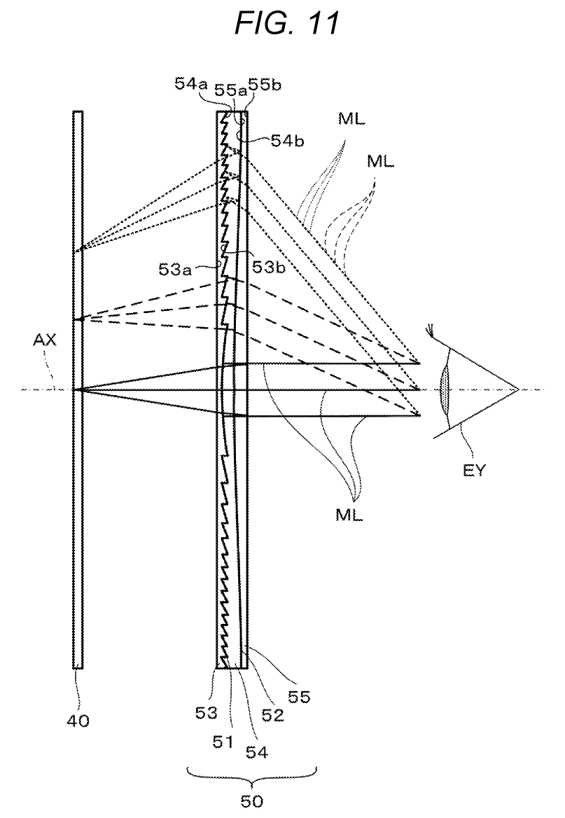

As shown in FIG. 11, the virtual image display apparatuses 100A and 100B according to the fourth embodiment primarily differ from the virtual image display apparatuses 100A and 100B according to the first embodiment shown in FIG. 7 in that the surface of the selectively reflective film 52 is changed in shape from the planar surface to a curved surface, as in the second embodiment shown in FIG. 9. In addition, the surface of the semi-transmissive reflective film 51 is changed in shape from the concave curved surface facing the selectively reflective film 52 to a concave Fresnel lens facing the selectively reflective film 52, as in the third embodiment shown in FIG. 10. In other words, the virtual image display apparatuses 100A and 100B according to the fourth embodiment primarily differ from the virtual image display apparatuses 100A and 100B according to the second embodiment shown in FIG. 9 in that the surface of the semi-transmissive reflective film 51 is changed in shape from the concave curved surface facing the selectively reflective film 52 to a concave Fresnel lens facing the selectively reflective film 52, as in the third embodiment shown in FIG. 10. Further in other words, the virtual image display apparatuses 100A and 100B according to the fourth embodiment primarily differ from the virtual image display apparatuses 100A and 100B according to the third embodiment shown in FIG. 10 in that the surface of the selectively reflective film 52 is changed in shape from the planar surface to a curved surface, as in the second embodiment shown in FIG. 9.

In the fourth embodiment, the shape of the Fresnel lens, which constitutes the semi-transmissive reflective film 51, and the shape of the curved surface of the selectively reflective film 52 are cooperatively responsible for the function of causing the video light ML that will reach the eye EY to converge so that the video light ML is brought into focus. As a result, in the fourth embodiment, the thickness, size, and weight of the see-through HMD 200 can be further reduced as compared with those in the first, second, or third embodiment.

### Variation: Time-division display unit

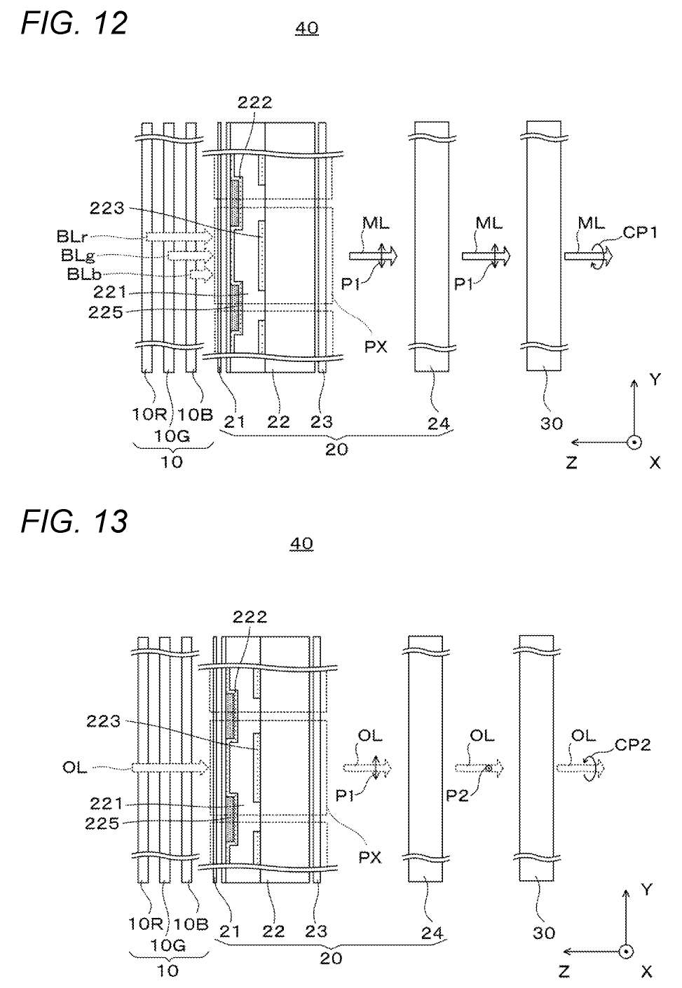

In the virtual image display apparatuses 100A and 100B according to the embodiments described above, the display unit 40 shown in FIG. 5 can be replaced with a time-division display unit 40 shown in FIGS. 12 and 13. The display unit 40 shown in FIGS. 12 and 13 is a variation of the display unit 40 shown in FIG. 5 achieved by changing the configuration of the transmissive light source member 10, removing the color filters 220r, 220g, and 220b from the transmissive liquid crystal panel 22, changing the first polarization region 23A to the second polarization region 23B shown in FIG. 4 out of the second polarizer 23, and adding a time-sequential half-wave, liquid crystal plate 24 between the second polarizer 23 and the quarter-wave plate 30.

In the display unit 40 shown in FIGS. 12 and 13, the transmissive light source member 10 includes a first transmissive light source member 10R, which generates first-color backlight BLr, a second transmissive light source member 10G, which generates second-color backlight BLg, and a third transmissive light source member 10B, which generates third-color backlight BLb. As an example, the first transmissive light source member 10R generates red light as the first-color backlight BLr, the second transmissive light source member 10G generates green light as the second-color backlight BLg, and the third transmissive light source member 10B generates blue light as the third-color backlight BLb. Note that the first transmissive light source member 10R, the second transmissive light source member 10G, and the third transmissive light source member 10B may each not include the transparent region 10T provided in the transmissive light source member 10 shown in FIG. 4, and may generate the multiple types of backlight BLr, BLg, and BLb via the entire surface of the first to third transmissive light source members.

The first transmissive light source member 10R, the second transmissive light source member 10G, and the third transmissive light source member 10B each operate when driven by the drive circuit 81 of the controller 80 shown in FIG. 2. The first transmissive light source member 10R, the second transmissive light source member 10G, and the third transmissive light source member 10B shown in FIGS. 12 and 13 each switch its operation state between a light emission state and a light transmission state in a time division manner under the control of the controller 80 shown in FIG. 2. The first transmissive light source member 10R, the second transmissive light source member 10G, and the third transmissive light source member 10B shown in FIGS. 12 and 13 generate the multiple types of backlight BLr, BLg, and BLb, respectively, in the light emission state, and do not generate the multiple types of backlight BLr, BLg, and BLb but transmit the external light OL in the light transmission state. Note that the second transmissive light source member 10G shown in FIGS. 12 and 13 may further transmit the backlight BLr in the light transmission state. The third transmissive light source member 10B shown in FIGS. 12 and 13 may further transmit the backlight BLr and BLg in the light transmission state.

The second polarizer 23 shown in FIGS. 12 and 13 has the second polarization region 23B shown in FIG. 4 disposed across the entire surface thereof, and does not have the first polarization region 23A. The second polarization region 23B transmits only the first linearly polarized light P1 of the incident light, as described with reference to FIG. 4. In the example shown in FIG. 4, the first linearly polarized light P1 is longitudinally or vertically polarized light. The polarization states of the video light ML and the external light OL having passed through the second polarizer 23 shown in FIGS. 12 and 13 are therefore each the first linearly polarization P1, for example, longitudinal or vertical polarization.

The time-sequential half-wave, liquid crystal plate 24 shown in FIGS. 12 and 13 switches its operation state between an ON state and an OFF state in a time-division manner under the control of the controller 80 shown in FIG. 2. The time-sequential half-wave, liquid crystal plate 24 shown in FIGS. 12 and 13 transmits the video light ML that is the first linearly polarized light P1 having passed through the second polarizer 23 with no change thereof in the ON state, whereas functioning as a half-wave plate, converting the external light OL that is the first linearly polarized light P1 having passed through the second polarizer 23 into the second linearly polarized light P2, and outputting the second linearly polarized light P2 in the OFF state. As an example, the time-sequential half-wave, liquid crystal plate 24 shown in FIGS. 12 and 13 may be configured with ferroelectric liquid crystal molecules.

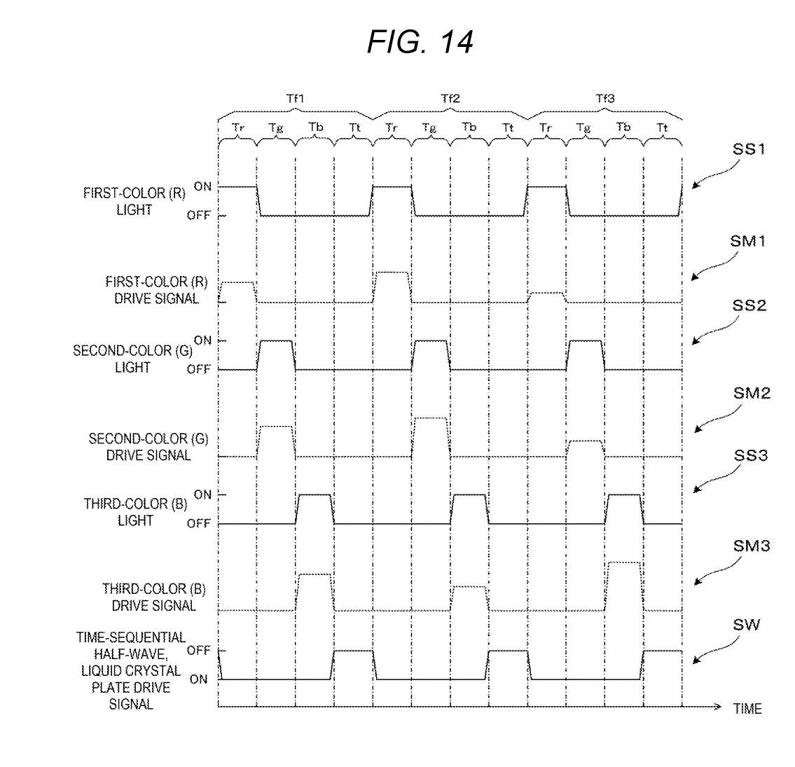

Drive signals used by the drive circuit 81 shown in FIG. 2 to drive the first transmissive light source member 10R, the second transmissive light source member 10G, the third transmissive light source member 10B, and the time-sequential half-wave, liquid crystal plate 24 shown in FIGS. 12 and 13 will be described with reference to the time chart shown in FIG. 14. The horizontal axis represents time, and a first blinking signal SS1, a first video signal SM1, a second blinking signal SS2, a second video signal SM2, a third blinking signal SS3, a third video signal SM3, and an on/off signal SW are shown sequentially from the top. The first blinking signal SS1 causes the first transmissive light source member 10R for the first color (R: red, for example) to emit light. The first video signal SM1 causes the transmissive liquid crystal panel 22 to form first-color video light. The second blinking signal SS2 causes the second transmissive light source member 10G for the second color (G: green, for example) to emit light. The second video signal SM2 causes the transmissive liquid crystal panel 22 to form second-color video light. The third blinking signal SS3 causes the third transmissive light source member 10B for the third color (B: blue, for example) to emit light. The third video signal SM3 causes the transmissive liquid crystal panel 22 to form third-color video light. The on/off signal SW switches the state of the time-sequential half-wave, liquid crystal plate 24 between the on state and the off state. Frame periods Tf1, Tf2, and Tf3 each include a first-color video observation period Tr, a second-color video observation period Tg, a third-color video observation period Tb, and an external light observation period Tt. The drive circuit 81 of the controller 80 shown in FIG. 2 outputs the blinking signals SS1, SS2, and SS3 to control the operation of the transmissive light source members 10R, 10G, and 10B, respectively, outputs the video signals SM1, SM2, and SM3 to control the operation of the transmissive liquid crystal panel 22, and outputs the on/off signal SW to control the operation of the time-sequential half-wave, liquid crystal plate 24.

In the first-color video observation period Tr, the first transmissive light source member 10R generates the first-color backlight BLr. The second transmissive light source member 10G and the third transmissive light source member 10B generate none of the second-color backlight BLg and the third-color backlight BLb but transmit the first-color backlight BLr. The transmissive liquid crystal panel 22 transmits the first-color backlight BLr to output the first-color video light representing the first color component out of the video light ML. The time-sequential half-wave, liquid crystal plate 24 operates in the ON state to output, as the first linearly polarized light P1, the first-color video light as the video light ML.

In the second-color video observation period Tg, the first transmissive light source member 10R does not generate the first-color backlight BLr. The second transmissive light source member 10G generates the second-color backlight BLg. The third transmissive light source member 10B does not generate the third-color backlight BLb but transmits the second-color backlight BLg. The transmissive liquid crystal panel 22 transmits the second-color backlight BLg to output the second-color video light representing the second color component out of the video light ML. The time-sequential half-wave, liquid crystal plate 24 operates in the ON state to output, as the first linearly polarized light P1, the second-color video light as the video light ML.

In the third-color video observation period Tb, the first transmissive light source member 10R and the second transmissive light source member 10G generate none of the first-color backlight BLr and the second-color backlight BLg. The third transmissive light source member 10B generates the third-color backlight BLb. The transmissive liquid crystal panel 22 transmits the third-color backlight BLb to output the third-color video light representing the third color component out of the video light ML. The time-sequential half-wave, liquid crystal plate 24 operates in the ON state to output, as the first linearly polarized light P1, the third-color video light as the video light ML.

In the external light observation period Tt, the first transmissive light source member 10R, the second transmissive light source member 10G, and the third transmissive light source member 10B generate none of the first-color backlight BLr, the second-color backlight BLg, and the third-color backlight BLb but transmit the external light OL. The transmissive liquid crystal panel 22 does not output the first color component, the second color component, or the third color component of the video light ML but transmits the external light OL. The time-sequential half-wave, liquid crystal plate 24 operates in the OFF state to convert the external light OL that is the first linearly polarized light P1 into the second linearly polarized light P2 and output the second linearly polarized light P2.

As described above, as a variation of each of the first to fourth embodiments, even in the configuration in which the time-division display unit 40 shown in FIGS. 12 and 13 is combined with the imaging optical system 50 shown in FIGS. 7, 9, 10, and 11, the video light ML output from the display unit 40 and the external light OL having passed through the display unit 40 can be superimposed on each other, and the combined light can reach the eye EY and can be observed therewith. This is because, also in the variation, the video light ML has the first circular polarization CP1 when output from the display unit 40, so that the video light ML brought into focus by the imaging optical system 50 reaches the eye EY, whereas the external light OL has the second circular polarization CP2 when passing through the display unit 40, so that the external light OL passes through the imaging optical system 50 and reaches the eye EY.

A virtual image display apparatus according to a specific aspect includes: a display panel configured to output video light and transmit external light; a selectively reflective film configured to reflect light circularly polarized in a first rotational direction as the light circularly polarized in the first rotational direction, and transmit light circularly polarized in a second rotational direction opposite the first rotational direction as the light circularly polarized in the second rotational direction; and a semi-transmissive reflective film provided between the display panel and the selectively reflective film and configured to transmit a part of incident light and reflect another part of the incident light. The semi-transmissive reflective film is configured to partially transmit the video light output from the display panel. The selectively reflective film is configured to reflect the video light passing through the semi-transmissive reflective film. The semi-transmissive reflective film is configured to partially reflect the video light reflected off the selectively reflective film. The selectively reflective film is configured to transmit the video light reflected off the semi-transmissive reflective film. The semi-transmissive reflective film is configured to transmit a part of the external light passing through the display panel. The selectively reflective film is configured to transmit the external light passing through the semi-transmissive reflective film.

The virtual image display apparatus described above, in which the semi-transmissive reflective film and the selectively reflective film are combined with each other, can make a see-through HMD that transmits the external light thin.

The virtual image display apparatus according to a specific aspect further includes a quarter-wave plate configured to convert, out of the video light and the external light, light linearly polarized in a first direction into the light circularly polarized in the first rotational direction, and convert, out of the video light and the external light, light linearly polarized in a second direction perpendicular to the first direction into the light circularly polarized in the second rotational direction.

In the virtual image display apparatus described above, by using a quarter-wave plate configured to convert linearly polarized light in different polarization directions into circularly polarized light having different rotation directions, the selectively reflective film can reflect or transmit the two types of circularly polarized light.

The virtual image display apparatus according to a specific aspect further includes: a first transparent member disposed between the display panel and the semi-transmissive reflective film and having a first surface facing the display panel and a second surface facing the semi-transmissive reflective film; and a second transparent member disposed between the semi-transmissive reflective film and the selectively reflective film and having a third surface facing the semi-transmissive reflective film and a fourth surface facing the selectively reflective film. The semi-transmissive reflective film is formed on at least one of the second surface of the first transparent member and the third surface of the second transparent member.

In the virtual image display apparatus described above, in which the semi-transmissive reflective film and the selectively reflective film are formed at surfaces of the transparent members, the positional relationship between the semi-transmissive reflective film and the selectively reflective film can be fixed.

In the virtual image display apparatus according to a specific aspect, the semi-transmissive reflective film has a concave first curved surface facing the selectively reflective film.

In the virtual image display apparatus according to a specific aspect, the semi-transmissive reflective film has a shape of a concave Fresnel lens facing the selectively reflective film.

In the virtual image display apparatus described above, the semi-transmissive reflective film can cause the video light to converge with the positive power so that the video light is brought into focus.

In the virtual image display apparatus according to a specific aspect, the selectively reflective film is formed on the fourth surface of the second transparent member.

The virtual image display apparatus according to a specific aspect further includes a third transparent member having a fifth surface facing the fourth surface of the second transparent member and a sixth surface facing the fifth surface, the second transparent member is disposed between the first transparent member and the third transparent member, the selectively reflective film is formed on the fourth surface of the second transparent member or the fifth surface of the third transparent member, and the selectively reflective film has a convex second curved surface facing the semi-transmissive reflective film.

In the virtual image display apparatus described above, in which the semi-transmissive reflective film and the selectively reflective film are formed at surfaces of the transparent members, the positional relationship between the semi-transmissive reflective film and the selectively reflective film can be fixed, and the semi-transmissive reflective film can cause the video light to converge with the positive power so that the video light is brought into focus.

An optical unit according to a specific aspect includes: a display panel configured to output video light and transmit external light; a selectively reflective film configured to reflect circularly polarized light having a polarization plane rotating in a first rotational direction as the circularly polarized light having a polarization plane rotating in the first rotational direction, and transmit circularly polarized light having a polarization plane rotating in a second rotational direction opposite the first rotational direction as the circularly polarized light having a polarization plane rotating in the second rotational direction; and a semi-transmissive reflective film provided between the display panel and the selectively reflective film and configured to transmit a part of incident light and reflect another part of the incident light. The semi-transmissive reflective film is configured to partially transmit the video light output from the display panel. The selectively reflective film is configured to reflect the video light passing through the semi-transmissive reflective film. The semi-transmissive reflective film is configured to partially reflect the video light reflected off the selectively reflective film. The selectively reflective film is configured to transmit the video light reflected off the semi-transmissive reflective film. The semi-transmissive reflective film is configured to transmit a part of the external light passing through the display panel. The selectively reflective film is configured to transmit the external light passing through the semi-transmissive reflective film.

The optical unit described above, in which the semi-transmissive reflective film and the selectively reflective film are combined with each other, can make a see-through HMD that transmits the external light thin.

What is claimed is:

1. A virtual image display apparatus, comprising:
a display panel configured to output video light and transmit external light;
a selectively reflective film configured to reflect light circularly polarized in a first rotational direction as the light circularly polarized in the first rotational direction, and transmit light circularly polarized in a second rotational direction opposite the first rotational direction as the light circularly polarized in the second rotational direction; and
a semi-transmissive reflective film provided between the display panel and the selectively reflective film and configured to transmit a part of incident light and reflect another part of the incident light,
wherein the semi-transmissive reflective film is configured to partially transmit the video light output from the display panel,
the selectively reflective film is configured to reflect the video light passing through the semi-transmissive reflective film,
the semi-transmissive reflective film is configured to partially reflect the video light reflected off the selectively reflective film,
the selectively reflective film is configured to transmit the video light reflected off the semi-transmissive reflective film,
the semi-transmissive reflective film is configured to transmit a part of the external light passing through the display panel, and
the selectively reflective film is configured to transmit the external light passing through the semi-transmissive reflective film.

2. The virtual image display apparatus according to claim 1, further comprising:
a quarter-wave plate configured to convert, out of the video light and the external light, light linearly polarized in a first direction into the light circularly polarized in the first rotational direction, and convert, out of the video light and the external light, light linearly polarized in a second direction perpendicular to the first direction into the light circularly polarized in the second rotational direction.

3. The virtual image display apparatus according to claim 1, further comprising:
a first transparent member disposed between the display panel and the semi-transmissive reflective film and having a first surface facing the display panel and a second surface facing the semi-transmissive reflective film; and
a second transparent member disposed between the semi-transmissive reflective film and the selectively reflective film and having a third surface facing the semi-transmissive reflective film and a fourth surface facing the selectively reflective film,
wherein the semi-transmissive reflective film is formed on at least one of the second surface of the first transparent member and the third surface of the second transparent member.

4. The virtual image display apparatus according to claim 3, wherein
the semi-transmissive reflective film has a concave first curved surface facing the selectively reflective film.

5. The virtual image display apparatus according to claim 3, wherein
the semi-transmissive reflective film has a shape of a concave Fresnel lens facing the selectively reflective film.

6. The virtual image display apparatus according to claim 3, wherein
the selectively reflective film is formed on the fourth surface of the second transparent member.

7. The virtual image display apparatus according to claim 4, further comprising:
a third transparent member having a fifth surface facing the fourth surface of the second transparent member and a sixth surface facing the fifth surface,
wherein the second transparent member is disposed between the first transparent member and the third transparent member,
the selectively reflective film is formed on the fourth surface of the second transparent member or the fifth surface of the third transparent member, and
the selectively reflective film has a convex second curved surface facing the semi-transmissive reflective film.

8. The virtual image display apparatus according to claim 7, wherein
power of a concave shape of the semi-transmissive reflective film is greater than the power of a convex shape of the selectively reflective film.

9. An optical unit, comprising:
a display panel configured to output video light and transmit external light;
a selectively reflective film configured to reflect light circularly polarized in a first rotational direction as the light circularly polarized in the first rotational direction, and transmit light circularly polarized in a second rotational direction opposite the first rotational direction as the light circularly polarized in the second rotational direction; and
a semi-transmissive reflective film provided between the display panel and the selectively reflective film and configured to transmit a part of incident light and reflect another part of the incident light,
wherein the semi-transmissive reflective film is configured to partially transmit the video light output from the display panel,
the selectively reflective film is configured to reflect the video light passing through the semi-transmissive reflective film,
the semi-transmissive reflective film is configured to partially reflect the video light reflected off the selectively reflective film,
the selectively reflective film is configured to transmit the video light reflected off the semi-transmissive reflective film,
the semi-transmissive reflective film is configured to transmit a part of the external light passing through the display panel, and
the selectively reflective film is configured to transmit the external light passing through the semi-transmissive reflective film.
